(19) United States
(12) Patent Application Publication
(10) Pub. No.: US 2019/0102564 A1
(43) Pub. Date: Apr. 4, 2019

(54) Automated Security Patch and Vulnerability Remediation Tool for Electric Utilities

(71) Applicants: BOARD OF TRUSTEES OF THE UNIVERSITY OF ARKANSAS, Fayetteville, AR (US); ARKANSAS ELECTRIC COOPERATIVE CORPORATION, Little Rock, AR (US)

(72) Inventors: Qinghua Li, Fayetteville, AR (US); Fengli Zhang, Fayetteville, AR (US); Philip Huff, Little Rock, AR (US)

(73) Assignees: BOARD OF TRUSTEES OF THE UNIVERSITY OF ARKANSAS, Fayetteville, AR (US); ARKANSAS ELECTRIC COOPERATIVE CORPORATION, Little Rock, AR (US)

(21) Appl. No.: 16/150,042

(22) Filed: Oct. 2, 2018

Related U.S. Application Data
(60) Provisional application No. 62/566,953, filed on Oct. 2, 2017.

(51) Int. Cl. G06F 21/57; G06F 8/65; G06N 3/08; G06N 5/04; G06N 3/04

(52) U.S. Cl. CPC G06F 21/577; G06F 8/65; G06F 2221/033; G06N 5/045; G06N 3/04; G06N 3/08

(57) ABSTRACT

A system and method for implementing a machine learning-based software for electric utilities that can automatically recommend a remediation action for a security vulnerability.

### RELATED APPLICATIONS

This application claims priority to U.S. Provisional Application No. 62/566,953 filed on Oct. 2, 2017, which is hereby incorporated in its entirety.

### STATEMENT REGARDING FEDERALLY SPONSORED RESEARCH & DEVELOPMENT

This invention was made with government support by the Department of Energy, under Award Number DE-0E0000779, Cost Center Number: 0402 03040-21-1602. The government has certain rights in the invention.

### INCORPORATION BY REFERENCE OF MATERIAL SUBMITTED ON A COMPACT DISC

Not applicable.

### BACKGROUND OF THE INVENTION

Patching security vulnerabilities continue to be a heavily manual intensive process in the energy sector. Energy companies spend a tremendous amount of human resources digging through vulnerability bulletins, determining asset applicability and determining remediation and mitigation actions. The U.S. energy sector faces a unique and formidable challenge in vulnerability and patch management. The NERC patching requirements in CIP-007-6 R2 heavily incentivize flawless vulnerability mitigation. It is not uncommon for utilities to have several hundred software vendors to monitor, several thousand vulnerabilities to assess, and tens of thousands of patches or mitigation actions to implement. Whereas most companies in other sectors do risk-based patching, electric utilities must address every patch in a short time span. Operators have to analyze each and every vulnerability and determine the corresponding remediation action.

A recommended practice for Vulnerability and Patch Management (VPM) issued by the U.S. Department of Homeland Security (DHS) is shown in FIG. 1. When a vulnerability or patch is identified, an organization needs to analyze whether the vulnerability will affect their systems by taking into consideration both vulnerability characteristics and asset information. Specifically, the VPM process consists of several parts: (1) obtaining applicable vulnerabilities and patches, (2) determining whether to patch (also called remediation action analysis here), (3) patch testing, (4) patch implementation, and (5) patch validation.

Many vulnerability and patch management automation tools have been developed for traditional IT networks, such as Symantec Patch Management, Patch Manager Plus by ManageEngine, Asset Management by SysAid, and Patch Manager by Solarwinds. These VPM solutions mainly address security issues for operating systems such as Windows, Mac, and Linux, and the applications running on these systems. They can automatically discover vulnerabilities and deploy available patches. For example, Symantec Patch Management can detect security vulnerabilities for various operating systems, and for Microsoft applications and Windows applications. It can provide vulnerability and patch information to operators, but it is not able to analyze vulnerabilities and make decisions about remediation actions by itself. Patch Manager Plus by ManageEngine discovers vulnerabilities and patches, and then automates the deployment of patches for Windows, Mac, Linux, and third-party applications. These solutions are mainly designed for commonly used operating systems and applications in traditional IT systems, but cannot be applied to electric systems mainly for two reasons. On the one hand, they are unable to handle vulnerabilities for control system devices such as Programmable Logic Controller (PLC), which are very important and common in electric systems. On the other hand, these solutions mostly deploy all available patches automatically regardless of asset or system differences, which is infeasible in electric systems since it may interrupt the system service.

Some VPM solutions have been provided specifically for electric systems by companies such as Flexera, FoxGuard Solutions, and Leidos. The main function of these solutions is to provide applicable vulnerabilities for electric systems. They ask software information from utilities, find applicable vulnerabilities and patches for the software, and then send applicable vulnerability information to utilities. They are unable to analyze vulnerabilities against the operating environment and make prioritized decisions on how to address the vulnerabilities. To help and drive VPM automation, some public vulnerability databases are also available such as National Vulnerability Database (NVD), and Exploit Database. NVD publishes discovered security vulnerabilities and provides the information and characteristics about these vulnerabilities. Exploit Database provides information about whether vulnerabilities can be exploited.

In order to ensure the security and reliability of power systems, NERC developed a set of Critical Infrastructure Protection (CIP) Cyber Security Reliability Standards to define security controls applying to identified and categorized cyber systems. It defines the requirements for Security Patch Management in CIP-007-6 R2. It requires the utilities to (1) identify patch sources for all installed software and firmware, (2) identify applicable security patches on a monthly basis, and (3) determine whether to apply the security patch or mitigate the security vulnerability. Identified patching sources must be evaluated at least once every 35 calendar days for applicable security patches. For those patches that are applicable, they must be applied within 35 calendar days. For the vulnerabilities that cannot be patched, a mitigation plan must be developed, and a timeframe must be set to complete these mitigations.

In the research area, some work has been done to analyze vulnerabilities and patches to help better understand vulnerabilities. Stefan et al. explored discovery, disclosure, exploit, and patch dates for about 8000 public vulnerabilities. Shahzad et al. studied the evolution of vulnerability life cycles such as disclosure date, patch date, and the duration between patch date and exportability date, and extracted rules that represent exploitation of hackers and the patch behavior of vendors. The work in studied software vendors' patch release behaviors such as how quickly vendors patch vulnerabilities and how vulnerability disclosure affects patch release. Li and Paxson investigated the duration of a vulnerability's impact on a code base, the timeliness of patch development, and the degree to which developers produce safe and reliable fixes. Treetippayaruk et al. evaluated vulnerabilities of the installed software version and the latest version and then decided whether to update the software based on the value of Common Vector Scoring System (CVSS) score. Most of these analyzed datasets are retrieved from public vulnerability databases, such as NVD and Open Sourced Vulnerability Database (OSVDB), but they do not combine vulnerability metrics with organizational context to analyze decision making. Our previous work has explored a real security vulnerability and patch management dataset from an electric utility to analyze characteristics of the vulnerabilities that electric utility assets have and how they are remediated in practice. However, that work does not study how to address these vulnerabilities.

### BRIEF SUMMARY OF THE INVENTION

In one embodiment, the present invention provides a machine learning-based software tool for electric utilities that can automatically recommend a remediation action for any security vulnerability, such as Patch Immediately and Use Mitigate Actions, based on the properties of the vulnerability and the properties of the asset that has the vulnerability.

In other embodiments, the present invention provides a system that can also provide the rationales for the recommended remediation actions so that human operators can verify whether the recommendations are reasonable or not.

In other embodiments, the present invention provides a system that will automate the vulnerability analysis and decision-making process, replace the current timely and tedious manual analysis, and advance the security vulnerability remediation practice from manual operations and automated operations, dramatically reducing the human efforts needed.

In other embodiments, the present invention provides a system that has an accuracy as high as 97%.

In other embodiments, the present invention provides a system that automates vulnerability and patch management for electric utilities. It can greatly reduce the human efforts needed for vulnerability and patch management with high effectiveness and is very easy to deploy. In addition to tremendously saving human resources involved in vulnerability and patch management, the embodiments of the present invention provide much more timely remediation of vulnerabilities, reduce the risks of vulnerabilities being exploited by attackers, and meet the CIP regulations with less efforts.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1: Vulnerability and patch management process.

FIG. 2: The framework of an embodiment of the present invention.

FIG. 3: CPE and CVE mapping.

FIG. 4: An example of a trained decision tree model.

FIG. 5: Decision tree prediction results.

FIG. 6: Monthly prediction accuracy.

FIG. 7: The time spent on reason code verification.

FIG. 8: Prediction accuracy for different tree sizes.

FIG. 9: Comparison with other machine learning models.

FIG. 10: The framework of extended machine learning engine.

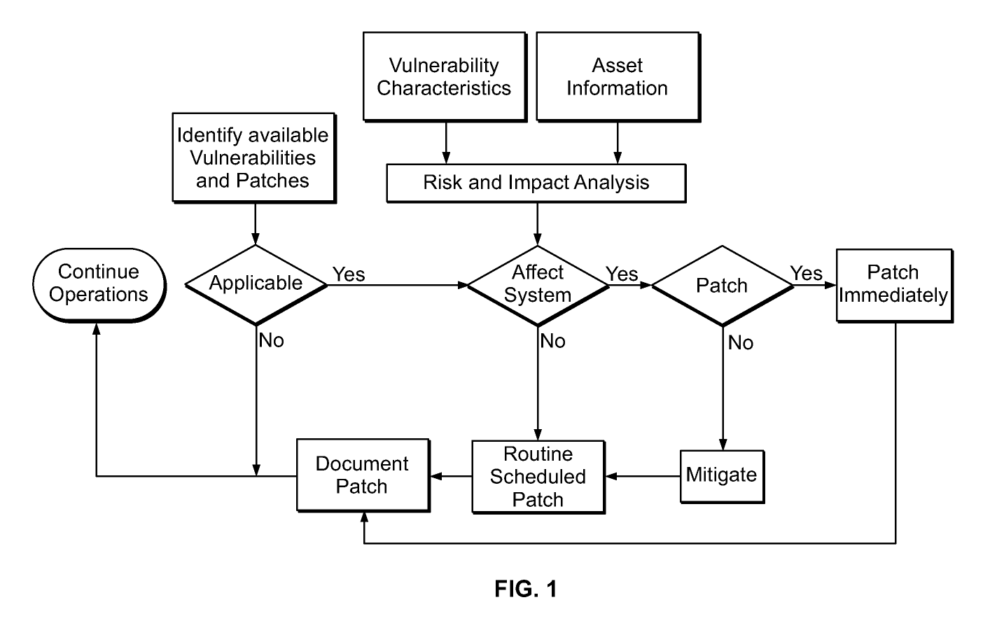

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

In one embodiment, the present invention uses a processor that implements software that models the reasoning and decision making of human operators in a utility in deciding the remediation actions for vulnerabilities in the past, and automatically predicts the human operator's decisions for future vulnerabilities/remediation actions. The present invention uses machine learning to learn human operators' past remediation decisions for vulnerabilities, and the learned model is used to predict future remediation actions.

In other embodiments, the learning model's input data is a vector consisting of two parts. The first part is vulnerability features, including Common Vulnerability Scoring System (CVSS) score, where the attack is from, attack complexity, privileges required, user interaction, confidentiality metric, integrity metric, availability metric, exploitability, remediation level, and report confidence. The second part is asset features, including asset name, asset group name, workstation user login, external accessibility, confidentiality impact, integrity impact, and availability impact. The labels include Patch Immediately, Mitigate, and Patch Later (i.e., in the next scheduled patching window).

In other embodiments, predicted decisions will be presented to human operators and rationales will be provided for each predicted decision, so that the human operator can quickly judge whether the predicted action is reasonable. Rationales are organized into well-designed reason code.

In other embodiments, a decision tree may be used as the learning model since it well resembles human reasoning and is easy to be interpreted. The learning model takes the vulnerability characteristics and asset characteristics as inputs, and the decisions as outputs. This model may be trained with the historical vulnerabilities and manual decisions data. When new vulnerabilities are fed into the trained model, the predicted decisions and the rationales will be outputted automatically. The rationales or reason code for a predicted decision will be derived from the tree path that leads to the predicted decision. The model may be updated periodically or as needed based on recent manual decisions. Predicted decisions can be seen as manual decisions after being verified by human operators and be used for model update.

In other embodiments, asset features can be assigned based on asset groups. In particular, similar assets or assets of the same function (e.g., switches) are categorized into the same group and share the same set of asset features. When a new asset is added to the system, it is added to an asset group and takes that group's features as its own asset features. That can reduce the cost of maintaining asset features for assets.

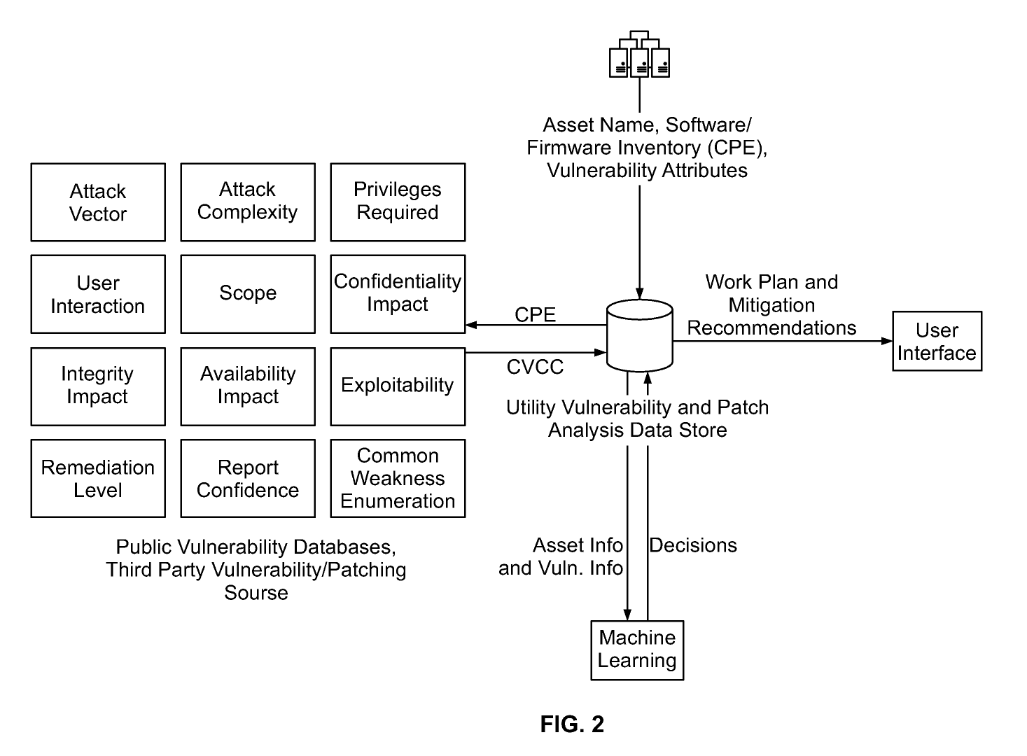

The framework of an embodiment of the present invention is shown in FIG. 2. It has a central database which includes asset data obtained from baseline configuration management systems and vulnerability data, especially CVSS attributes obtained from vendors, third-party services and/or public databases (i.e., NVD). Based on the database and past operation records and expert inputs, a machine learning engine automatically obtains applicable vulnerabilities, analyzes vulnerabilities, recommends remediation decisions (i.e., patch quickly or defer patching) for vulnerabilities. For recommended remediation decisions, the engine can also output a simple, easy-to-verify reason code for each recommended decision, so that human operators can understand and validate the machine learning.

When security operators make a decision about how to address vulnerabilities, asset information has to be considered. To do so efficiently, assets can be grouped, and asset characteristics can be specified by the group. Due to a large amount of assets in a utility, it is cumbersome to analyze and maintain the characteristic values for each asset. In order to reduce the cost of maintenance, assets can be divided into asset groups based on their roles or functions. For example, all Remote Terminal Units (RTUs) of a specific vendor and function can be categorized into one group since they have similar features. Similarly, all firewalls can be in one group. The assets in the same group share the same set of values for asset characteristics. Then human operators can determine and maintain the characteristic values for each group. Since the number of groups is much smaller than the number of assets, grouping will greatly reduce the number of efforts needed in maintaining characteristic values.

Each vulnerability is identified by a unique Common Vulnerability Enumeration (CVE) ID, and vulnerability characteristics are defined in CVSS metrics. They can be obtained in three ways:

Software or vulnerability inventory tools, which scan the cyber assets and report applicable vulnerabilities. Via these tools, CVE and CVSS can be obtained.

Obtain the CVE and CVSS directly from vendors through some reporting mechanism on authorized patches. For example, Microsoft has a mechanism to release CVE and CVSS for their vulnerabilities.

Use third-party services or public vulnerability databases such as Foxguard Solutions to obtain the CVSS of applicable vulnerabilities. This is required at some level to ensure completeness for every cyber asset.

In other aspects, the present invention provides a method for retrieving vulnerabilities from NVD, an open vulnerability database. Applicable vulnerabilities for a utility can be identified through determining the Common Platform Enumeration (CPE) names of assets and then mapping CPEs to the CVEs/CVSSs in the database. This activity may be performed by the organization directly or, through a third-party service.

CPE is a structured naming scheme to describe and identify classes of applications, operating system, and hardware devices present among a company's assets. Each software has a unique corresponding CPE name. CPE names follow a formal name format, which is a combination of several modular specifications. Each specification specifies the value for one attribute, such as attribute vendor=“Microsoft”, which implies the value of the “product's vendor” attribute is Microsoft. Then the specifications are bound in a predefined order to generate the CPEs.

In other aspects, the present invention may use the latest CPE version 2.3 name format: cpe:2.3:part:vendor:product:version:update:*:*:*:*. The part attribute describes the product's type: an application (“a”), operating systems (“o”), or hardware (“h”). Values for vendor attribute identify the manufacturer of the products. Products and version attributes describe the product name and release version respectively. Values for the update attribute characterize the particular update of the product, i.e., beta. For example, cpe:2.3:a:microsoft: internet_explorer:8.0.6001:beta:*:* represents the application internet explorer released by Microsoft. Star * is used to represent the attributes whose values are not specified. If one wants to identify a general class of products, he does not have to include all the attributes. For example, he does not have to include the version and update attributes in CPE names. If one wants to describe a specific product, he can bind more attributes such as the version, edition or updates.

Baseline configuration management tools can provide a collection of information about the installed products, such as vendor and version. From this collection of information, the utility can search through the list of CPE names available in the NVD to find those that match the installed products. Utility companies can also generate the CPE names for their products by following the above formats, but it should be noted that the string values be consistent to the CPE dictionaries in NVD. For example, if a utility sets the product value as “internet explorer” while the CPE dictionary uses “internet_explorer,” it may wrongly identify different products from the NVD.

The NVD publishes vulnerabilities for a variety of products daily. Each vulnerability is identified by a unique Common Vulnerability Enumeration (CVE) ID, such as CVE-2016-8882. It provides which products are affected by the vulnerability by specifying the products CPE names under the vulnerability. Each vulnerability also comes with Common Vulnerability Scoring System (CVSS) metrics which describe the vulnerability features. The features and their possible values are shown in Table 1.

TABLE 1
Vulnerability Characteristics

| CVSS Score | Exploitability | | | | Attack Vector | | |
|---|---|---|---|---|---|---|---|
| Value in 0-10 | High | Functional | Proof-of- | Unproven | Network | Adjacent | Local |
| | | | Concept | | | | |

| Attack Complexity | | User Interaction | | | Privilege | | |
|---|---|---|---|---|---|---|---|
| High | Low | High | Medium | Low | Multiple | Single | None |

| Confidentiality Impact | | | Integrity Impact | | | Availability Impact | | |
|---|---|---|---|---|---|---|---|---|
| Complete | Partial | None | Complete | Partial | None | Complete | Partial | None |

The CVSS score is a number between 0 and 10 determined by the metrics to describe, in general, a vulnerability's overall severity. Attacker Vector shows how a vulnerability can be exploited, e.g., through the network or local access. Exploitability indicates the likelihood of a vulnerability being exploited. High as the highest level means exploit code has been widely available, and Unproven as the lowest level means no exploit code is available, with two other levels in between.

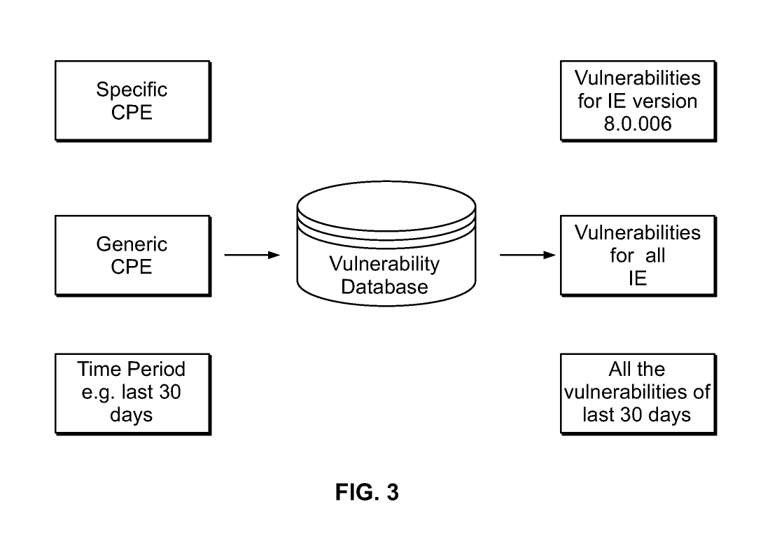

Obtaining vulnerabilities through CPE/CVE mapping. As introduced above, the installed software in a utility can be identified with CPE names. And for each published vulnerability, it has corresponding CPE names to show which products are affected by the vulnerability. Therefore, a utility can use the CPE names to query the NVD and get the applicable CVEs and CVSSs for their assets. The NVD can be downloaded to local servers and updated as frequently as desired. Then a local search engine can be used to obtain vulnerabilities, as shown in FIG. 3. The search engine supports queries of vulnerabilities released in a certain time span (i.e., last 30 days) with specific CPEs or generic CPEs. If a utility wants to obtain vulnerability information for a specific application, it can use a more specific CPE. Otherwise, a more generic vendor or application CPE search string can be used. A more generic search string requires less maintenance but has the tradeoff of requiring more work for the analyst in determining applicability. The generic vendor or application CPE is useful for software vendors who do not have many vulnerabilities.

The CPE and CVE mapping method may also be adapted to obtain vulnerabilities from other vulnerability sources such as Microsoft and Redhat's own vulnerability database. Vulnerabilities from the common vendors are published in NVD and follow the CVSS standard. For example, Microsoft identifies its vulnerabilities with CVE ID and evaluates the vulnerabilities with CVSS metrics. Then its vulnerabilities will be published to its own vulnerability database and NVD. Redhat also publishes its vulnerabilities with CVE ID.

After obtaining vulnerability information, operators analyze the vulnerability and asset characteristics to determine a remediation plan. When making decisions, operators have some rules in mind and follow these rules to address vulnerabilities. However, these rules depend on many factors, and many of these rules need to be tuned very finely to make the right decisions. Accordingly, the present invention uses, machine learning technologies to automate remediation action analysis. A prediction model is trained first over historical operation data. Then for a new vulnerability, the model takes the vulnerability's asset characteristics and vulnerability characteristics as inputs and outputs a predicted remediation action. This prediction tries to mimic operators' manual decisions in an automated way. To apply machine learning technologies, the following may be considered: what features to be selected, what machine learning model to be used, and how to train the model. Additionally, the machine learning model may be enabled to generate reason codes for predictions so humans can understand and validate the predictions.

Both vulnerability characteristics and asset characteristics should be considered to make decisions. Since vulnerability characteristics are well defined and provided through CVSS, the CVSS metrics in Table 1 may be used as vulnerability features. Of course, the vulnerability features are not limited to CVSS metrics and all CVSS metrics do not have to be considered as features.

Asset features are also critical for decision making. When assets are maintained through asset groups, features for each group may be used rather than each asset. Some typical asset features that can be used are as follows:

Interactive Workstation: (Yes or No)—Whether the cyber asset provides an interactive workstation for a human operator. If the cyber asset does not have an interactive user, then vulnerabilities affecting applications such as web browsers would have significantly less impact.

External Accessibility: (High, Authenticated Only or Limited)—The degree to which cyber assets are externally accessible outside of the cyber system. For example, High may mean a web server providing public content, and Authenticated-Only may be a group of remotely accessible application servers which require login before use.

Confidentiality Requirement: (High, Medium or Low)—The confidentiality requirement of the asset group. If it is set as “High,” loss of confidentiality will have a severe impact on the asset group.

Integrity Requirement: (High, Medium or Low)—The integrity requirement of the asset group.

Availability Requirement: (High, Medium or Low)—The availability requirement of the asset group.

Unlike vulnerabilities, asset feature selection may vary from utility to utility. Different asset characteristics may be selected as features for different utilities. In general, the following asset characteristics can be considered as features: the characteristics that are very important to assets and considered when operators make decisions; and the characteristics that correspond to vulnerability characteristics. For example, asset feature ‘Confidentiality Requirement’ corresponds to vulnerability features ‘Confidentiality Impact.’

Many machine learning algorithms are available. However, the decision tree model may be used to automate remediation action analysis for the following reasons: (1) Decision tree mimics human thinking. When people make decisions, they usually first consider the most important factor and classify the problem into different situations. For each situation, they will consider the second most important factor and do further classification for each situation. Then they repeat the above procedures until a final decision is made. The process of decision tree-based decision exactly resembles human reasoning. On each level of the tree, the model chooses the most important factor and splits the problem space into multiple branches based on the factor's value. (2) Unlike many other machine learning models such as logistic regression and Support Vector Machine (SVM) that are like black boxes, the decision tree model allows a user to see what the model does in every step and know how the model makes decisions. Thus, the predictions from decision tree can be interpreted, and a reason code can be derived to explain predictions. Human operators can verify the predictions based on reason code, which allows the option of dynamic model training based on these verified predictions.

The decision tree model can be trained from historical manual operation data that contains vulnerability information, asset information, and remediation decisions for a set of historical vulnerabilities. Most utilities keep historical vulnerability and decision data for future retrieval and government inspection.

The asset information may be collected and then combined with historical vulnerability and decision data to form training dataset. The training process tries to learn the logic of operators' decision making. The trained model may be used to predict remediation decisions for future vulnerabilities.

It is very difficult to form a predictive machine learning tool to be 100% accurate. To enable trust, the machine learning engine generates an easy-to-verify reason code for each prediction so that operators can quickly verify whether the predicted decision is reasonable or not. The selection of a decision tree model makes reason code generation feasible. A trained decision tree model is a bunch of connected nodes and splitting rules. One can analyze the model and understand each node of the tree and its splitting rule. Then the reason code for each leaf node (decision node) can be derived by traversing the tree path and combining the splitting rules of the nodes in the path. However, for some long paths, the generated reason code could become very long, redundant and hard to read. Therefore, two rules were designed to simplify and shorten reason codes.

Intersection: redundancy, can be reduced by finding range intersection. For example, for continuous data such as CVSS scores, if one condition in the reason code is “CVSS Score is larger than 5.0” and the other condition is “CVSS Score is larger than 7.0”, the intersection may be found and the reason code can be reduced to “CVSS Score is larger than 7.0”. For the categorical data such as exploitability, the reason code “exploitability is not unproven, exploitability is not functional, and exploitability is high” can be reduced to “exploitability is high.”

Complement: for some features that appear in several conditions of a path, the conditions can be replaced by using its complementary condition. For example, for integrity impact, the set of possible values is Complete, Partial, None. If the reason code is “Integrity impact is not None, and integrity impact is not partial,” since the complement of Partial, None is Complete, the reason code can be reduced to “Integrity is Complete.”

Vulnerability features are universally defined by CVSS metrics. In the dataset, each vulnerability comes with a CVSS metric. CVSS metrics may be used as vulnerability features. In the dataset, the utility has three optional remediate actions to address vulnerabilities: Patch Later for vulnerabilities that have no impact and can be patched in the next scheduled patching cycle, Patch Immediately or Mitigate for vulnerabilities that have impacts on assets and need to be addressed immediately.

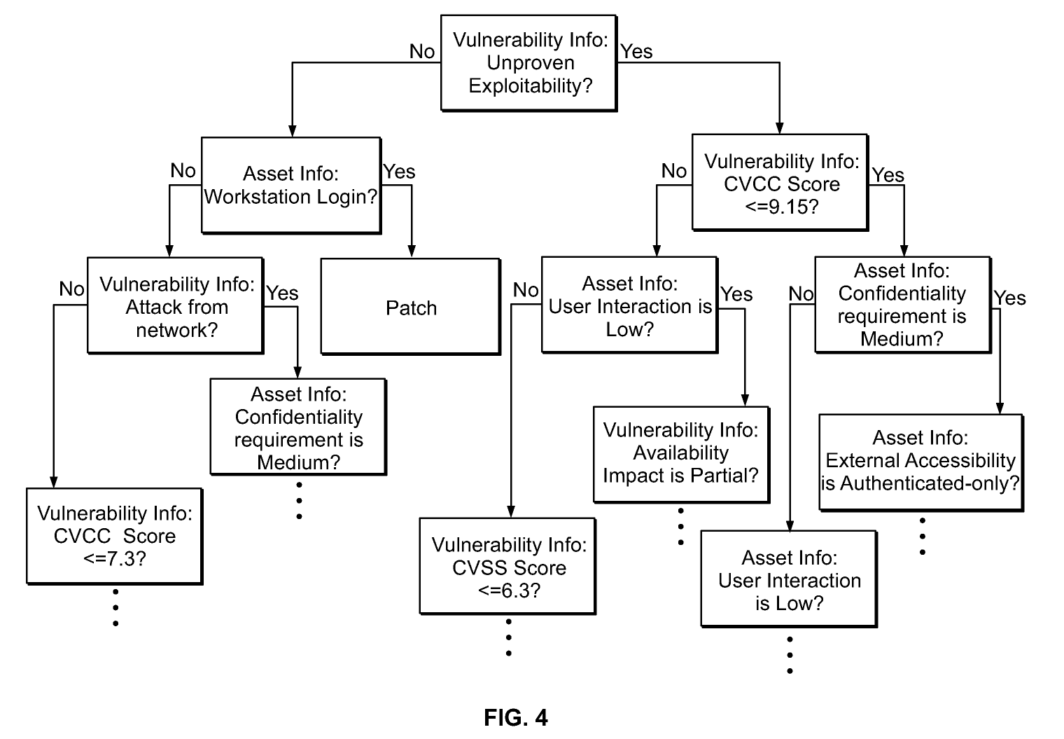

The decision tree model was implemented based on library Scikit-learn in Python. The tree's maximum depth is set as 50, and the minimum number of samples at a leaf node is set as 8, which means if the number of samples in a node is less than or equal to 7, it will stop splitting. The dataset is split into training data and testing data. Training data is used to train the decision tree model, while testing data is used to test the performance of the trained model. For illustration purposes, FIG. 4 shows a simple decision tree model in the remediation action analysis context. The prediction process for a vulnerability based on this tree is as follows. When a new data record is fed into the model, the model will first look at the exploitability feature. If the exploitability is not Unproven, it will go to check the asset feature “workstation login.” If the workstation allows user login, it means it faces more dangers and must be patched immediately. Other tree branches can be traversed in similar ways.

Reason code for each prediction is generated in two steps. In the first step, the reason code for each leaf node (decision node) can be derived by traversing the tree path from a root to this leaf and combining the splitting rules of the nodes in the path. For example, as shown in FIG. 4, if a predicted decision is made through the path “Unproven exploitability?→Workstation Login?→Patch”, then the generated reason code is “the exploitability is unproven, and the workstation allows user login.” However, for some long paths (e.g., with 18 nodes), the reason code could become very long. Thus, in the second step, the intersection rule and complement rule are applied to shorten reason codes.

For each vulnerability, the present invention outputs three parts after analyzing input data: predicted decision, confidence, and reason code, as shown in Table 2.

TABLE 2
Sample prediction results

| Predicted action | Confidence | Reason code |
|---|---|---|
| Patch Later | 1 | Unproven Exploitability, CVSS Score |
| | | is less than 4.2 and Medium |
| | | Confidentiality Impact |
| Mitigate | 0.91 | Proof-of-Concept Exploitability, |
| | | Network Attack, High External |
| | | Accessibility and High |
| | | Confidentiality Impact |
| Patch Immediately | 1 | not Unproven Exploitability and |
| | | this Workstation allows users' login |

Note that predicted decisions could be different for different utilities depending on their ways to address vulnerabilities. Predicted confidence shows how confident the tool makes the prediction. Reason code helps human operators to understand and verify the prediction. Table 2 shows examples of the predictions for three different vulnerabilities. The first one shows the predicted action is ‘Patch Later’ with 100% confidence. The reason why the tool makes such prediction is that the vulnerability is not exploitable, the CVSS score is less than 4.2 which means it has a low impact on assets, and it has medium confidentiality impact. The other two can be interpreted in a similar way.

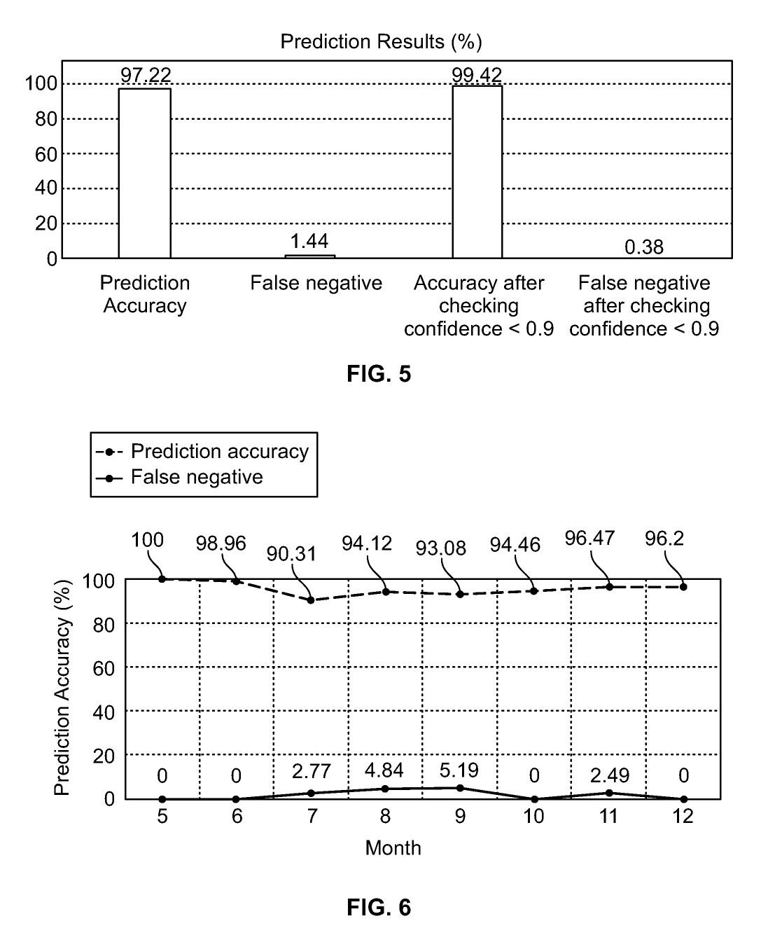

In one analysis, the dataset was randomly split into two parts, 70% for training and 30% for testing. Prediction accuracy is defined as the fraction of predicted decisions that are the same as a manual decision. The false negative rate is defined as the fraction of cases where the prediction is Patch Later, but the manual decision is Patch Immediately or Mitigate. False negatives may cause severe results if the vulnerabilities that should be remediated immediately are not remediated in time, and thus it should be minimized. The prediction accuracy of an embodiment of the present invention are shown in FIG. 5. The prediction accuracy can be up to 97.22%. False negative is 1.44%. If vulnerabilities with a prediction confidence under 0.9 receive operators' manual check, prediction accuracy can be improved to 99.42%.

The number of conditions a reason code has denotes its length. For example, the length of reason code “Unproven Exploitability, CVSS Score is less than 4.2 and Medium Confidentiality Impact” is 3 because it includes 3 conditions. The average length of reason code is 6.9 conditions. After applying the reduction rules, the average length is reduced to 3.6 conditions. For example, the reason code “Unproven Exploitability, CVSS Score is less than 9.15, External Accessibility is not High, CVSS Score is less than 6.30, External Accessibility is not Authenticated-Only and Medium Availability Impact” can be reduced to “Unproven Exploitability, CVSS Score is less than 6.3, Limited External Accessibility and Medium Availability Impact”.

Twelve months of data were randomly split into training data and testing data, which are not in the temporal order. However, in practice, historical data was used to train the model and predict decisions for future vulnerabilities. Since a power system is dynamic and displays seasonality, the rules of older historical data. Thus, the present invention only uses recent four months' historical data to train a model and predict for the next month's vulnerabilities. The prediction results are shown in FIG. 6. The x-axis means which month it is predicted for and y-axis is the prediction accuracy. For example, when the x-axis is 5, it means that it uses the first four months' data to train the model and then predicts decisions for the fifth month. Then it uses the data from the second month to the fifth month to predict for the sixth month's vulnerabilities. The prediction accuracy is not very stable for different months, but overall it is high. The best prediction performance is 100% prediction accuracy and 0% false positive rate. The lowest prediction accuracy is 90.31% with 2.77% false negative rate.

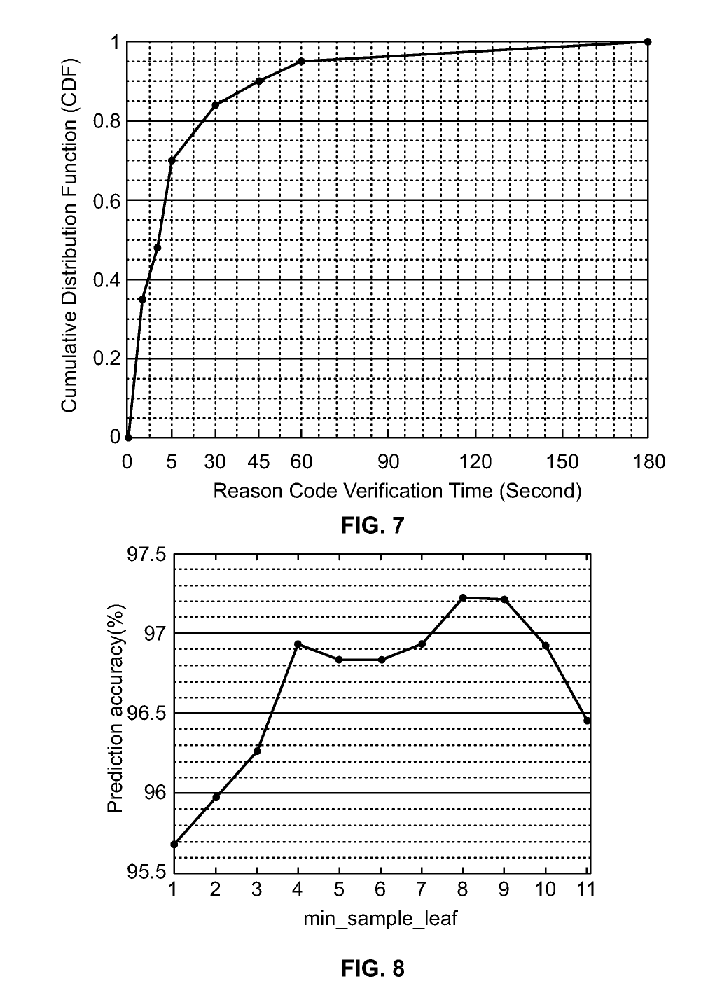

Based on the operators' feedback, 98 out of the 100 reason codes were found to be sufficient to verify the predicted decisions. One decision was found to be wrongly predicted through the reason code verification. Only One reason code was insufficient to verify the predictions. The time spent on reason code verification is shown in FIG. 7, which shows that most of the reason codes can be verified in a very short time.

The present invention has a high prediction accuracy with around 97%, but there is still about 3% false predictions. To decrease the false prediction rate, it is worth exploring where the false predictions come from and how to decrease these. Based on our observation and exploration on the falsely predicted vulnerabilities, it was found that false predictions mainly happen in two situations: the decision tree is not deep enough to make right predictions, and same vulnerabilities are remediated with different actions, which can confuse the decision tree.

The path that the vulnerability goes through should go deep enough so that the tool can consider more features to make the right decisions. For example, the decision tree makes the decision “Patch Later” for a vulnerability with the reason “Unproven Exploitability, CVSS Score is less than 8.4 and Medium Availability Impact”. However, the right decision should be “Patch Immediately” because this vulnerability has high external accessibility. The decision tree path stops without checking the feature “external accessibility” by believing such vulnerabilities should be patched later regardless of the condition of “external accessibility.”

One straightforward idea to solve such a problem is to build a deeper and larger decision tree so that the tree can include all kinds of situations. Ideally, if the tree is large enough, it can build a path for each possibility during the training process. However, this will result in overfitting, which also decreases the overall prediction accuracy as shown in FIG. 8. “min_samples_leaf” is the minimum number of samples required to be at a leaf node, which means if the number of samples at a node is less than “min_samples_leaf,” this node will stop splitting. The smaller “min_samples_leaf” is, the more the tree splits and the deeper and larger the tree is. As shown in FIG. 8, when “min_samples_leaf” is 8, it has the highest prediction accuracy of 97.22%. When “min_samples_leaf” decreases, the prediction accuracy decreases since the tree is too specific to generalize to new samples. If “min_samples_leaf” is too large where the tree is short and small, the prediction accuracy also decreases because the trained tree does not capture important information of the training data.

As the experiment results show, building a deeper tree is not a feasible solution in such a situation. Verifying the reason codes can help reduce such false prediction rate since it can be captured by the reason codes if the tree path does not go deep enough.

Same vulnerabilities are remediated by different actions:

It was determined that in historical data, some vulnerabilities with exactly the same characteristics on same assets have different remediation actions. For such vulnerabilities, the decision tree will assume the major action for the vulnerability is the right decision. For example, there are four vulnerabilities with same characteristics presenting on one asset, three of which were remediated by “Patch Later” and one was remediated by “Patch Immediately.” The decision tree will think “Patch Later” is the right decision with confidence 0.75.

This situation is not uncommon since not all the vulnerabilities are analyzed by one operator. In a utility company, there are always a group of security operators who are responsible for VPM. Different operators may have different decisions even on same vulnerabilities presenting on the same asset. This shows that there is some bias even when a human decides on how to address vulnerabilities.

When there are different remediation actions for the same vulnerabilities, the decision tree usually selects the major action as predicted decisions. These false predictions can also be reduced through operators' verification since the prediction confidence under such situations is usually not 1. When the confidence is relatively low, operators will be asked to verify the decisions to avoid such wrong predictions.

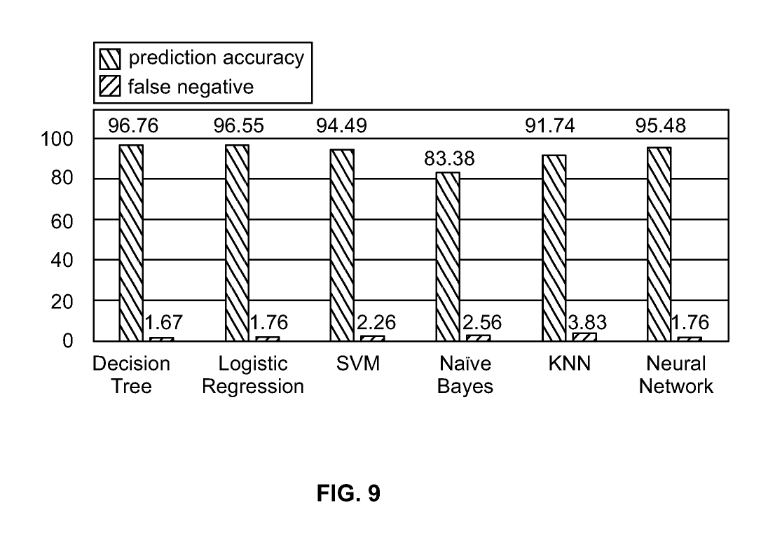

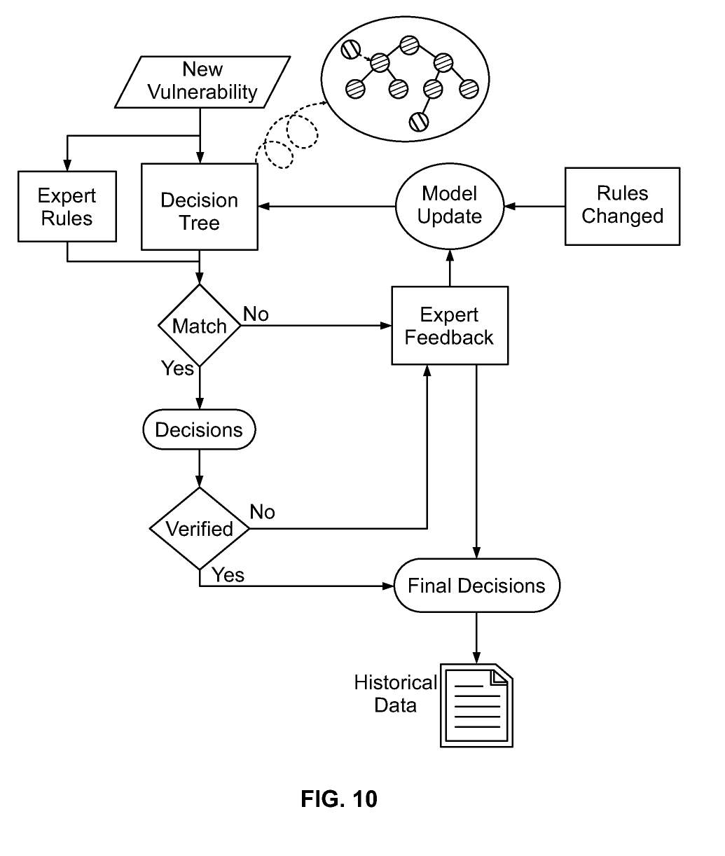

FIG. 9 shows how the decision tree model of the present invention performs compared with other popular machine learning models: logistic regression, support vector machine (SVM), Naive Bayes, k-nearest neighbors (KNN) and neural network. All the models were trained with the same training dataset, and all the predicted results were obtained through the same testing data. It can be seen that the decision tree model performs better than other models. The decision tree has 96.76% prediction accuracy and 1.67% false negative predictions. Logistic regression and neural network are also very promising models and have similar performances with a decision tree. Logistic regression has slightly higher false negative rate than decision tree. A neural network has the same false negative rate but slightly lower prediction accuracy than a decision tree.

A neural network is a very powerful model in many problems. Mostly, a neural network is like a black box, and the trained model is a bunch of formulas and parameters. It is very difficult to understand what each parameter or formula means and why the neural network model makes such decisions. However, it is necessary to interpret the predictions in some circumstances.

The rationalization of neural network could be solved by extracting some pieces of input text as justification, and determining which features are considered and used when making decisions.

A decision tree and a rationalized neural network model may be compared in three aspects: prediction accuracy, false negative rate and generated reason codes. When reason codes are sufficient to support predictions, shorter reason codes are much better and easier to interpret. The results are shown in Table 3, which the decision tree performs much better than a rationalized neural network, especially on reason codes.

TABLE 3
Comparison between decision tree and neural network model

| | Prediction | False | Length of |
|---|---|---|---|
| | accuracy (%) | negative (%) | reason code |
| Decision tree | 96.76 | 1.67 | 4.11 |
| Neural network | 94.97 | 2.87 | 8.48 |

The average length of reason codes generated by the decision tree is about 4, while the average length of the rationalized neural network is around 8.5. Since the reason codes of the decision tree are already sufficient to verify the predictions, the ones of a rationalized neural network might be redundant and more time-consuming for operators to read. The prediction accuracy of a decision tree is about 2% higher than a rationalized neural network, and the false negative rate is about 1.2% lower.

The present invention has implemented the vulnerability search engine to obtain applicable vulnerabilities by mapping CPEs and CVEs. To retrieve applicable vulnerabilities corresponding CPEs are obtained for all the software of the utility. Since CPE names involve many string values, they have to be generated carefully so that they are consistent with the CPE names in NVD CPE dictionary.

The machine learning engine predicts decisions based on a set of training data, and over time the prediction may need modification. In one instance, the predicted decision may not represent a consensus of security best practice, or the organization may want additional assurance that the decision meets regulatory expectations. For this, the machine learning may be extended to include expert rules.

Also, the machine learning engine outputs reason codes to verify predicted decisions. However, when a decision is found wrongly predicted through operators' verification, it will continue making such wrong predictions if it is not corrected. Thus, the machine learning engine should be able to accept operators' feedback to update the model. In addition, the machine learning engine must address the dynamics of electric systems. These dynamic situations may be asset and vulnerability characteristic changes not covered by existing metrics, and business and reliability requirement changes for the electric utility.

Decisions on how to best address vulnerabilities may be based on new information not explicitly captured in existing vulnerability and asset metrics. For example, a workstation may allow interactive login, but the human operator is not allowed to access any Internet sites due to a new policy. This may all but eliminate the risk of a given browser-based vulnerability. A security operator may see this reoccurring decision for browser-based vulnerabilities and decide to update the machine learning for one or more of the workstations.

If business rules have changed, the old machine learning model cannot be applied anymore and has to be updated. Business rules of an organization and reliability rules of the power grid may change in a way that would impact VPM decisions. For example, a need arises that a generation control system must run throughout an extended period to support the reliability of the power grid. Or a change freeze may be issued for a control system to support the implementation of a new project. In these two examples, patching cannot be done to relevant assets since that will interrupt their operations, and mitigation plans might be used instead. If the change is recurring or extensive, the security operator may wish to update the machine learning model to incorporate this new information.

The above situations may be solved by adding more functions to machine learning engines. The framework of the extended machine learning engine is shown in FIG. 11. In addition to analyzing vulnerabilities, predicting decisions and providing reason codes, four more functions are enabled in the machine learning engine: Expert rules, Match, Model update, and Rule update.

Expert rules are expert-defined rules to address certain vulnerability and asset characteristic combinations. Expert rules may not be as specific as the decision tree, and they only cover some cases that the utilities want to pay more attention to or specially address. They can be used to check the validity of those cases of vulnerabilities. Vulnerabilities will be fed into both the expert rule module and the decision tree engine. If a prediction for any of the applicable cases is consistent with expert rules, it gives operators more confidence that this prediction is trustable; if a prediction of any applicable case is inconsistent with expert rules, this prediction should be checked manually. For those cases not matched to expert rules, one the decision tree's predictions will be considered.

It is difficult for a decision tree model to cover all possible instances. If an input data has never appeared before, which means there is no perfectly matched decision tree path for this data, the model has no solid knowledge to make predictions for it. Then this data will be shown to experts to make decisions. This data and its corresponding decisions will be saved as historical data for later decision tree model training. This function is very critical especially at the beginning stage of a model building when there are no many historical data.

It is found that wrongly predicted decisions happen mostly because the decision tree path stops while it should go deeper to check more features. A deeper and larger tree can be built to avoid this. However, it can easily cause overfitting. An appropriate size for the tree should be chosen to guarantee the overall performance even though some paths cannot cover some important features. Then the module “Model Update” can update some decision tree paths specifically to correct the wrongly predicted decisions. For example, two vulnerabilities go through the same path and are made with the same decisions, but one's decision is wrongly made. When it is verified by experts, it is found that one vulnerability has high confidentiality impact which should result in a different decision, but this feature is not checked by the decision tree path. Then “Model Update” will add an offspring node to the path and make the added node check the confidentiality impact. Overall, when decisions are found wrongly predicted, experts can provide decision rules especially for this type of vulnerabilities. Through comparing the decision tree paths, the vulnerabilities go through, and the provided rules, “Model Update” module can automatically update the decision tree model by making offspring paths.

It may happen that some rules are too old and out of date, which needs to be updated. For example, the remediation action is always “patch immediately” when a type of vulnerability presents in asset A. However if this vulnerability cannot be patched anymore and have to be mitigated because of some configuration changes, the trained decision tree cannot be used to predict this vulnerability. Then the decision tree model should be updated by changing the decision tree path that the vulnerability goes though.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A system for implementing a machine learning-based software for electric utilities that can automatically recommend a remediation action for a security vulnerability, the system comprising:
a processor programmed to implement said machine learning-based software, said software adapted to learn past remediation decisions for past vulnerabilities to create a learned model; and
said learned model is used to predict future remediation actions.

2. The system of claim 1 wherein the input to said model is a vector consisting of two parts.

3. The system of claim 2 wherein said first part of said vector is a feature of a vulnerability.

4. The system of claim 3 wherein said vulnerability feature includes one or more of the following: CVSS score, where the attack is from, attack complexity, privileges required, user interaction, confidentiality metric, integrity metric, availability metric, exploitability, remediation level, and report confidence.

5. The system of claim 4 wherein said second part of said vector is a feature of an asset.

6. The system of claim 5 wherein said asset feature includes one or more of the following: asset name, asset group name, workstation user login, external accessibility, confidentiality impact, integrity impact, and availability impact.

7. The system of claim 6 wherein said labels include Patch Immediately, Mitigate, and Patch Later.

8. The system of claim 7 wherein the predicted decisions are presented to a user and rationales are provided for each predicted decision.

9. The system of claim 8 wherein rationales are organized into one or more reason codes.

10. The system of claim 9 wherein a decision tree is used as the learning model and said one or more reason codes are derived from tree paths.

11. The system and method of claim 10 wherein said asset features are assigned based on asset groups.
